(19) United States
(12) Patent Application Publication
(10) Pub. No.: US 2025/0070684 A1
(43) Pub. Date: Feb. 27, 2025

(54) ELECTRIC POWER CONVERSION DEVICE AND CONTROL METHOD FOR ELECTRIC POWER CONVERSION DEVICE

(71) Applicants: KABUSHIKI KAISHA TOSHIBA, Tokyo (JP); TOSHIBA ENERGY SYSTEMS & SOLUTIONS CORPORATION, Kawasaki-shi Kanagawa (JP)

(72) Inventors: Shunsuke KAWACHI, Tama Tokyo (JP); Yukina AKIYAMA, Kawasaki Kanagawa (JP); Yuki KUDO, Fuchu Tokyo (JP); Yoko SAKAUCHI, Fuchu Tokyo (JP); Koji TOBA, Tama Tokyo (JP); Kenji MITSUMOTO, Setagaya Tokyo (JP); Daisuke TAKEDA, Kawasaki Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi Kanagawa (JP)

(21) Appl. No.: 18/719,583

(22) PCT Filed: Dec. 15, 2021
(86) PCT No.: PCT/JP2021/046345

§ 371 Date: Jun. 13, 2024

(51) Int. Cl. H02M 7/44

(52) U.S. Cl. CPC H02M 7/44

(57) ABSTRACT

An electric power conversion device according to an embodiment includes: a converter circuit that converts direct current power to alternating current power; a circuit breaker one end of which is connectable to an external system and another end of which is connected to the converter circuit via a filter circuit; and an injector that, before injecting the circuit breaker during activation, sets the converter circuit to an operating state, determines whether a voltage at the one end and a voltage at the other end meet a synchronization condition, and injects the circuit breaker when the synchronization condition is met.

### CROSS-REFERENCE TO RELATED APPLICATIONS

This application is national stage application of International Application No. PCT/JP2021/046345, filed Dec. 15, 2021, which designates the United States, incorporated herein by reference.

### FIELD

Embodiments described herein relate generally to an electric power conversion device and a control method for the electric power conversion device.

### BACKGROUND

In recent years, the ratio of an inverter power supply is increasing due to the introduction of renewable energy and the like.

In particular, in systems in remote islands and remote areas that are independent from large-scale systems, it is desirable to supply electric power mainly from the renewable energy to reduce fuel costs and perform decarbonization. In such the systems, the main power supply facilities include PV, wind power, and storage batteries. Hence, the inverter power supply ratio is expected to become significantly large.

On the other hand, a rotary-type power supply such as a diesel generator (DG) has an important role as a stable power supply. In independent systems, it is expected that a small capacity DG and a large number of inverter power supplies are used in combination.

Incidentally, when the inverter power supplies are interconnected, there has been a problem in that the advanced reactive power of the filter capacitor is supplied from an external system.

To solve this problem, there has been developed a technology in which inverter power supplies are independently activated and synchronized with the system after the filter capacitor is charged, the interconnection circuit breaker is injected, and the operation is switched to a system interconnection mode.

However, in the technology described above, the control may become unstable when the system to be connected is mainly composed of inverters and the operation is switched to the system interconnection mode.

### BRIEF DESCRIPTION OF DRAWINGS

FIG. 1 is a schematic configuration block diagram of an inverter power supply of an embodiment.

FIG. 2 is a functional block diagram of a controller of a first embodiment.

FIG. 3 is a process flowchart of a controller of the embodiment.

FIG. 4 is an explanatory diagram of an example of a transfer function for calculating a voltage correction signal Vcorr.

FIG. 5 is an explanatory diagram of an example of a transfer function for calculating a frequency correction signal Fcorr.

FIG. 6 is an explanatory diagram of an example of a transfer function for calculating a phase θ in the first embodiment.

FIG. 7 is an explanatory diagram of an example of a transfer function for calculating a d-axis voltage command value Vdref in the first embodiment.

FIG. 8 is an explanatory diagram of an example of a transfer function for calculating the phase θ in a second embodiment.

FIG. 9 is an explanatory diagram of an example of a transfer function for calculating the d-axis voltage command value Vdref in the second embodiment.

FIG. 10 is a schematic configuration block diagram of an electric power supply system of a third embodiment.

FIG. 11 is an explanatory diagram of an example of a transfer function for calculating the frequency correction signal Fcorr in the third embodiment.

### DETAILED DESCRIPTION

According to one embodiment, an electric power conversion device includes: a converter circuit that converts direct current power to alternating current power; a circuit breaker one end of which is connectable to an external system and another end of which is connected to the converter circuit via a filter circuit; and an injector that, before injecting the circuit breaker during activation, sets the converter circuit to an operating state, determines whether a voltage at the one end and a voltage at the other end meet a synchronization condition, and injects the circuit breaker when the synchronization condition is met.

Next, embodiments will be described with reference to the accompanying drawings.

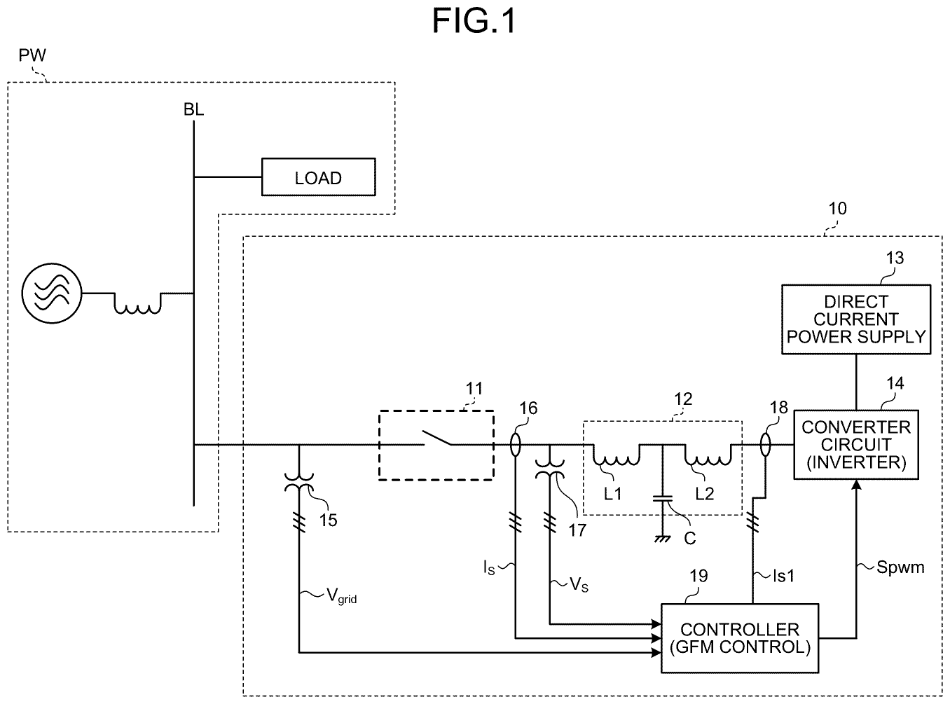

FIG. 1 is a schematic configuration block diagram of an inverter power supply of an embodiment.

An inverter power supply 10 is controlled by Grid ForMing (GFM) control.

As illustrated in FIG. 1, the inverter power supply 10 includes a circuit breaker 11 connected to a bus line BL configuring an external system PW; a filter circuit 12 that functions as an interconnection reactor connected in series with the circuit breaker 11; a direct current power supply 13 that supplies direct current power; a converter circuit 14 configured as an inverter circuit, that performs direct current to three-phase alternating current conversion, and that supplies direct current power Pdc to a load; a first voltage sensor 15 that detects the voltage (U-phase voltage, V-phase voltage, and W-phase voltage) on the bus line BL side of the circuit breaker 11, and that outputs a first voltage detection signal Vgrid; a first electric current sensor 16 that detects the electric current (U-phase electric current, V-phase electric current, and W-phase electric current) between the circuit breaker 11 and the filter circuit 12, and that outputs a first electric current detection signal Is; a second voltage sensor 17 that detects the voltage (U-phase voltage, V-phase voltage, and W-phase voltage) between the circuit breaker 11 and the filter circuit 12, and that outputs a second voltage signal Vs; a second electric current sensor 18 that detects the electric current (U-phase electric current, V-phase electric current, and W-phase electric current) between the filter circuit 12 and the converter circuit 14, and that outputs a second electric current detection signal Is 1; and a controller 19 that controls an inverter configuring the converter circuit 14 in GFM control mode, and that controls the whole inverter power supply 10.

In the configuration described above, the external system PW includes the load connected to the bus line BL, and the inverter power supply 10 is connected in parallel with the load. Moreover, the inductor illustrated in the external system PW is a virtual representation of impedance on the system side.

Then, in conjunction with the external system PW, the inverter power supply 10 supplies alternating current power to the load via the bus line BL.

Moreover, the filter circuit 12 includes two coils L1 and L2 and a capacitor C, and is configured as a T-type low-pass filter.

The general operation of the inverter power supply 10 of the embodiment during normal operation will now be described.

When the circuit breaker 11 is injected, three-phase alternating current power is supplied from the external system PW to the filter circuit 12 via a filter reactor FL.

The first electric current sensor 16 of the inverter power supply 10 detects the electric current (U-phase electric current, V-phase electric current, and W-phase electric current) between the circuit breaker 11 and the filter circuit 12, and outputs the first electric current detection signal Is to the controller 19.

Moreover, the second voltage sensor 17 detects the voltage (U-phase voltage, V-phase voltage, and W-phase voltage) between the circuit breaker 11 and the filter circuit 12, and outputs a second voltage detection signal Vs to the controller 19.

Consequently, the controller 19 calculates electric power using the values obtained by converting the coordinates of the electric current based on the first electric current detection signal Is, and the voltage based on the second voltage detection signal Vs, from the fixed coordinates (abc coordinate system) into the rotating coordinates (dq coordinate system).

Subsequently, the controller 19 performs droop-based GFM control on the basis of the value of the calculated electric power and the value of the voltage on the rotating coordinate axis, and calculates the phase θ of the output voltage and the d-axis voltage command value Vdref of the output voltage.

Then, on the basis of the calculated phase θ and d-axis voltage command value Vdref, the controller 19 calculates the voltage command value on the fixed coordinate axis, performs PWM conversion, and outputs a PWM control signal Spwm to the converter circuit 14.

As a result, on the basis of the PWM control signal Spwm, the converter circuit 14 performs a direct current to three-phase alternating current conversion on the direct current power input from the direct current power supply 13, converts the direct current power into the alternating current power, and supplies the converted alternating current power to the external system PW via the filter circuit and the circuit breaker 11.

As a result of the above, it is possible to suppress the effects of voltage fluctuation or current fluctuation of the three-phase alternating current power supplied from the external system PW, and supply stable alternating current power to the external system PW.

### First Embodiment

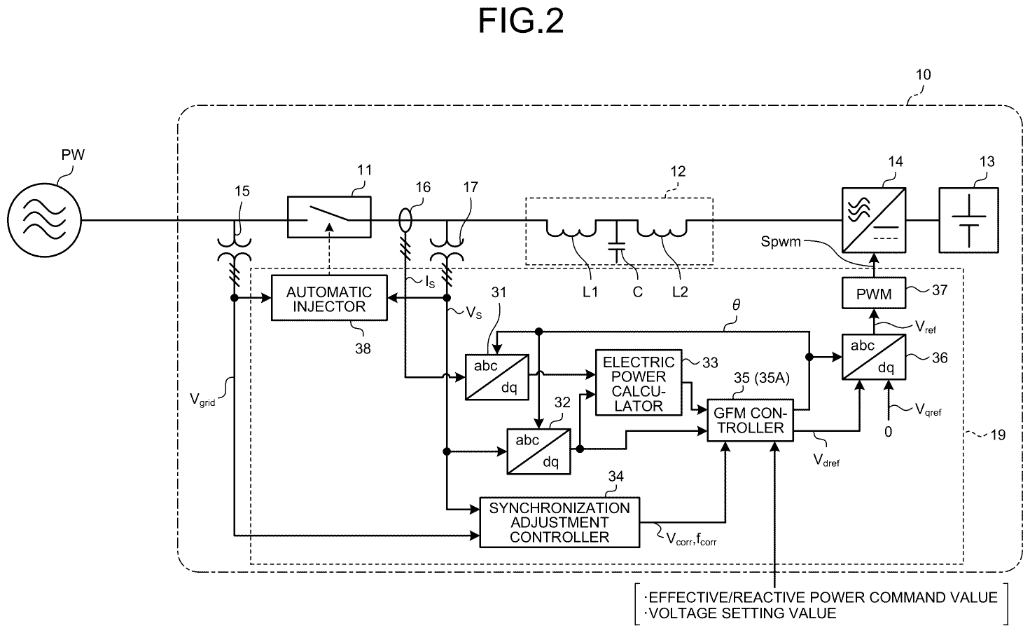

FIG. 2 is a functional block diagram of a controller of a first embodiment.

As illustrated in FIG. 2, the controller 19 of the inverter power supply 10 in the first embodiment includes a first coordinate system conversion unit 31 that performs abc-dq conversion on the first electric current detection signal Is on the basis of the phase θ, and outputs the converted electric current detection signal Is; a second coordinate system conversion unit 32 that converts the voltage detection signal Vs from the abc coordinate system to the dq coordinate system (abc-dq conversion) on the basis of the phase θ, and outputs the converted voltage detection signal Vs; an electric power calculator 33 that calculates electric power on the basis of the voltage detection signal Vs on which the abc-dq conversion is performed and the current detection signal on which the abc-dq conversion is performed; a synchronization adjustment controller 34 that calculates and outputs the voltage correction signal Vcorr and the frequency correction signal Fcorr, on the basis of the first voltage detection signal Vgrid output by the first voltage sensor 15 and the second voltage detection signal Vs output by the second voltage sensor 17; a GFM controller 35 that calculates the phase θ of the output voltage and the d-axis voltage command value Vdref of the output voltage, by performing droop-based GFM control on the basis of the value of the electric power calculated by the electric power calculator 33 and the value of the voltage detection signal Vs on which the abc-dq conversion is performed; a third coordinate system conversion unit 36 that converts the d-axis voltage command value Vdref and a q-axis voltage command value Vqref from the dq coordinate system into the abc coordinate system (dq-abc conversion) on the basis of the phase θ, and outputs the converted d-axis voltage command value Vdref and q-axis voltage command value Vqref as the reference voltage signals Vref; a PWM controller 37 that generates a PWM control signal Spwm on the basis of the reference voltage signal Vref, and that performs PWM control on the converter circuit 14 configured as an inverter circuit; and an automatic injector 38 that injects the circuit breaker 11 by determining that the synchronization conditions are met, when each difference between the amplitudes, frequencies, and phases of both voltages is equal to or less than a threshold, on the basis of the first voltage detection signal Vgrid and the second voltage detection signal Vs.

In the configuration described above, in the present first embodiment, the GFM controller 35 performs droop-based GFM control as the voltage-controlled converter control. The GFM controller 35 proportionally reduces the frequency of the output voltage, when the output of the inverter power supply is increased, and proportionally increases the frequency of the output voltage, when the output of the inverter power supply is reduced.

Next, the operation of the first embodiment will be described.

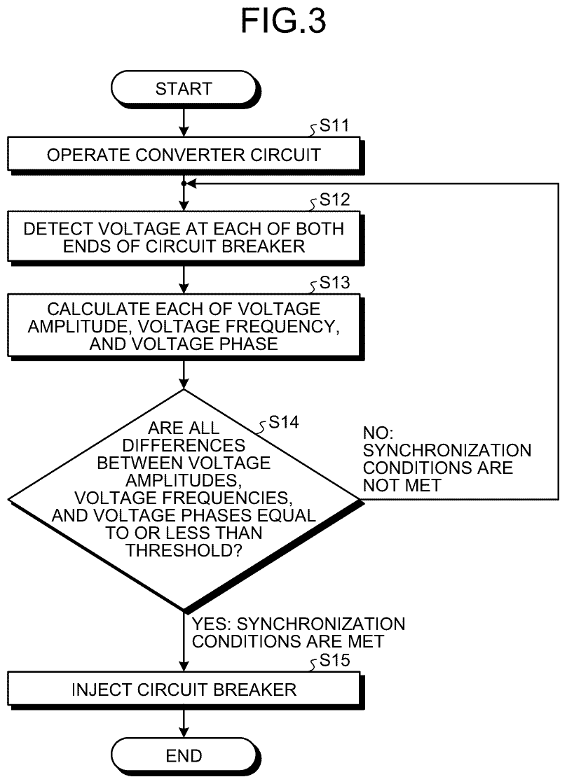

FIG. 3 is a process flowchart of a controller of the embodiment.

In the initial state, it is assumed that the circuit breaker 11 is in an open state (off state), and the external system PW is in an operating state.

When the operator operates the inverter power supply 10, the controller 19 outputs a predetermined PWM control signal Spwm corresponding to the time of operation, activates (deblocks) the converter circuit 14, sets the converter circuit 14 to an operating state (step S11), and causes the direct current power supply 13 to supply direct current power.

As a result, the capacitor C in the filter circuit 12 is charged, and the three-phase alternating current power is then supplied. Hence, voltage is applied to one end of the circuit breaker 11 on the filter circuit 12 side.

In this process, the second voltage sensor 17 detects the voltage (U-phase voltage, V-phase voltage, and W-phase voltage) between the circuit breaker 11 and the filter circuit 12, and outputs the second voltage detection signal Vs to the controller 19 (step S12).

On the other hand, the first electric current sensor 16 detects the electric current (U-phase electric current, V-phase electric current, and W-phase electric current) between the circuit breaker 11 and the filter circuit 12, and outputs the first electric current detection signal Is to the second coordinate system conversion unit 32, the synchronization adjustment controller 34, and the automatic injector 38 of the controller 19.

Consequently, the controller 19 calculates electric power using the values obtained by converting the coordinates of the electric current based on the first electric current detection signal Is, and the voltage based on the second voltage detection signal Vs, from the fixed coordinates (abc coordinate system) into the rotating coordinates (dq coordinate system). However, at this point, because the circuit breaker 11 is in an open state, the electric power is zero.

At the same time, when the external system PW is in an operating state, the three-phase alternating current power from the external system PW is supplied, and voltage is applied to one end of the circuit breaker 11 on the bus line BL side.

In this process, the first voltage sensor 15 detects the voltage (U-phase voltage, V-phase voltage, and W-phase voltage) between the circuit breaker 11 and the bus line BL, and outputs the first voltage detection signal Vgrid to the synchronization adjustment controller 34 and the automatic injector 38 of the controller 19 (step S12).

As a result of the above, the synchronization adjustment controller 34 calculates the voltage correction signal Vcorr and the frequency correction signal Fcorr on the basis of the first voltage detection signal Vgrid and the second voltage detection signal Vs, and outputs the calculated voltage correction signal Vcorr and frequency correction signal Fcorr to the GFM controller 35.

The calculation of the voltage correction signal Vcorr and the frequency correction signal Fcorr will now be described.

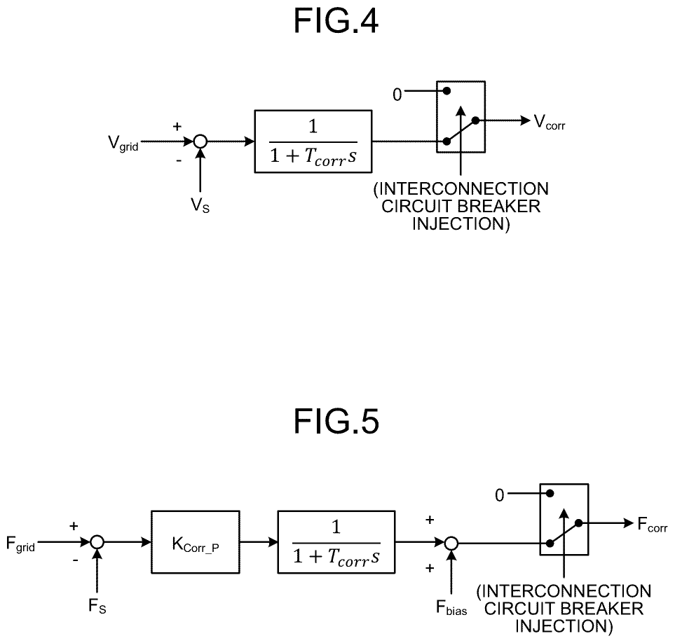

FIG. 4 is an explanatory diagram of an example of a transfer function for calculating the voltage correction signal Vcorr.

In more detail, the voltage correction signal Vcorr is calculated according to the transfer function illustrated in FIG. 4, on the basis of a system voltage effective value Vgrid [PU: notation in PU method] and an inverter power supply voltage effective value [PU].

In this case, when the circuit breaker 11 is injected, voltage correction signal Vcorr=0 [PU] holds.

FIG. 5 is an explanatory diagram of an example of a transfer function for calculating the frequency correction signal Fcorr.

In more detail, the frequency correction signal Fcorr is calculated according to the transfer function illustrated in FIG. 5, on the basis of the system frequency Fgrid [PU], the inverter power supply frequency, and the frequency bias Fbias.

In this case, when the frequencies on the system side and the inverter power supply side completely match with each other, the phase difference does not change, and the synchronization conditions will never be met. Hence, the frequency bias Fbias is applied to intentionally shift the frequency.

In this case also, when the circuit breaker 11 is injected, frequency correction signal Fcorr=0 [PU] holds.

As a result of the above, the GFM controller 35 performs the droop-based GFM control on the basis of the calculated value of electric power, the value of the second voltage Vs on the rotating coordinate axis, the voltage correction signal Vcorr, and the frequency correction signal Fcorr. Also, the GFM controller 35 calculates the phase θ of the output voltage and the d-axis voltage command value Vdref of the output voltage, and outputs the phase θ to the first coordinate system conversion unit 31, the second coordinate system conversion unit 32, and the third coordinate system conversion unit 36, and outputs the d-axis voltage command value Vdref to the third coordinate system conversion unit 36.

The calculation of the phase θ and d-axis voltage command value Vdref in the first embodiment will now be described.

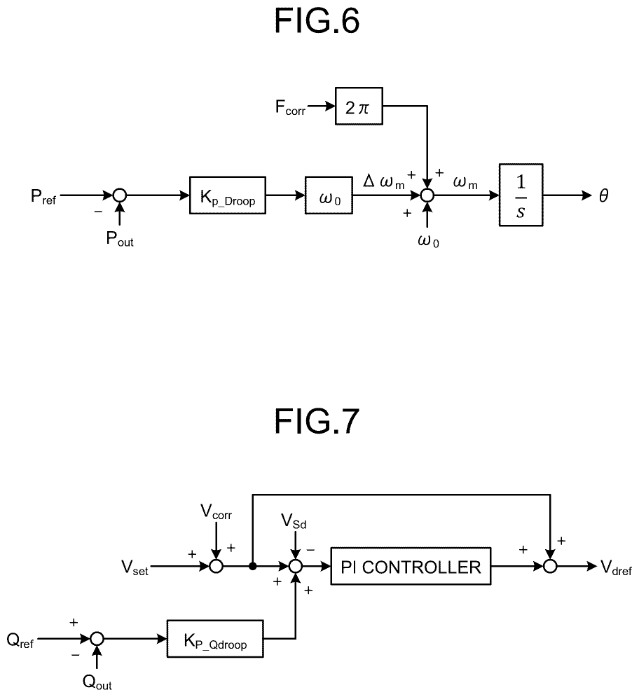

FIG. 6 is an explanatory diagram of an example of a transfer function for calculating the phase θ in the first embodiment.

In more detail, the phase θ is calculated according to the transfer function illustrated in FIG. 6, on the basis of an effective power command value Pref, an inverter power supply effective power output Pout, the frequency correction signal Fcorr, and reference angular velocity ω0.

FIG. 7 is an explanatory diagram of an example of a transfer function for calculating the d-axis voltage command value Vdref in the first embodiment.

In more detail, the d-axis voltage command value Vdref is calculated according to the transfer function illustrated in FIG. 7, on the basis of a reactive power command value Qref, an inverter power supply reactive power output Qout, a voltage command value Vset, and an inverter power supply d-axis output voltage Vsd.

Then, the first coordinate system conversion unit 31 performs abc-dq conversion on the first electric current detection signal Is on the basis of the phase θ, and outputs the converted electric current detection signal Is. Moreover, the second coordinate system conversion unit 32 converts the voltage detection signal Vs from the abc coordinate system to the dq coordinate system (abc-dq conversion) on the basis of the phase θ, and outputs the converted voltage detection signal Vs. Furthermore, the third coordinate system conversion unit 36 converts the d-axis voltage command value Vdref and the q-axis voltage command value Vqref from the dq coordinate system to the abc coordinate system (dq-abc conversion) on the basis of the phase θ, and outputs the converted d-axis voltage command value Vdref and q-axis voltage command value Vqref to the PWM controller 37 as the reference voltage signals Vref.

The PWM controller 37 generates the PWM control signal Spwm on the basis of the reference voltage signals Vref, outputs the PWM control signal Spwm to the converter circuit 14, and performs PWM control on the converter circuit 14 configured as an inverter circuit.

In this case, in the droop-based GFM control performed by the GFM controller 35 of the controller 19, in a phrase control, the GFM controller 35 calculates and outputs the phase θ of the output voltage, by calculating a deviation Δω of the angular frequency of the output voltage, in proportion to the difference between the output effective power of the inverter power supply and the effective power command value, and integrating the value obtained by adding the reference angular velocity ω0 to the deviation Δω.

Moreover, in controlling the voltage, the GFM controller 35 corrects the output voltage amplitude, by calculating the correction amount of the command value of the d-axis component of the output voltage in proportion to the difference between the output reactive power of the inverter power supply 10 and the reactive power command value.

Along with the operation described above, of the voltages at both ends of the circuit breaker 11, the automatic injector 38 calculates each of the voltage amplitude, voltage frequency, and voltage phase, on the basis of the input first voltage detection signal Vgrid and second voltage detection signal Vs (step S13).

Subsequently, the automatic injector 38 determines whether each difference between the voltage amplitudes, the voltage frequencies, and the voltage phases at both ends of the circuit breaker 11 is equal to or less than a threshold (step S14).

In the determination at step S14, if any difference between the voltage amplitudes, voltage frequencies, and voltage phases at both ends of the circuit breaker 11 exceeds a threshold (No at step S14), it is determined that the synchronization conditions are not met, and the process proceeds to step S12.

In the determination at step S14, if the differences between the voltage amplitudes, voltage frequencies, and voltage phases at both ends of the circuit breaker 11 are all equal to or less than a threshold (Yes at step S14), it is determined that the synchronization conditions are met, and the circuit breaker 11 is injected and turned ON (step S15).

As described above, according to the present first embodiment, in a state where the inverter power supply is performing GFM control for building up the voltage while changing the frequency of the output voltage according to the output electric power of the inverter power supply, the circuit breaker 11 is injected when the synchronization conditions are met, that is, of the voltages at both ends of the circuit breaker 11, when the differences between the voltage amplitudes, voltage frequencies, and voltage phases at both ends of the circuit breaker 11 are all equal to or less than a threshold. Consequently, there is no need to switch the control of the inverter power supply to the system interconnection control to follow the voltage and frequency of the external system PW, after the circuit breaker 11 is injected.

Moreover, the inverter power supply can be operated continuously and stably, even if the frequency or voltage of the external system fluctuates after the system interconnection.

Furthermore, it is possible to stably activate the inverter power supply without depending on the status (the short-circuit capacity and the size of inertia) of the system to be interconnected.

### Second Embodiment

Next, a second embodiment will be described.

Because an inverter power supply of the second embodiment has the same configuration as the inverter power supply of the first embodiment, the description will be made with reference to FIG. 2 again.

An inverter power supply 10A in the second embodiment is different from the inverter power supply 10 in the first embodiment in using virtual synchronous generator control (VSG control), as the control performed by a GFM controller 35A.

In this example, the virtual synchronous generator control (VSG control) is the voltage-controlled converter control, and is assumed to simulate the mechanical frequency change characteristics of a synchronous generator.

Next, the calculation of the phase 0 and the d-axis voltage command value Vdref in the second embodiment will be described.

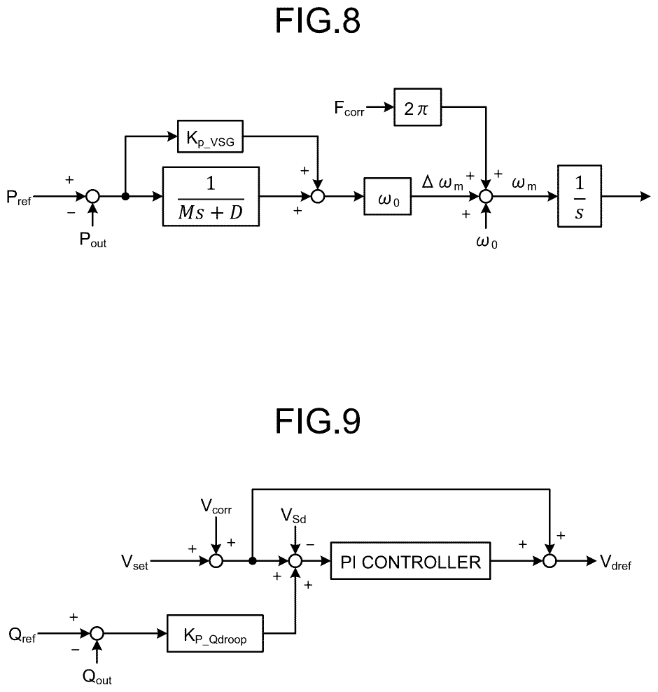

FIG. 8 is an explanatory diagram of an example of a transfer function for calculating the phase θ in the second embodiment.

In more detail, the phase θ is calculated according to the transfer function illustrated in FIG. 8, on the basis of the effective power command value Pref, the inverter power supply effective power output Pout, the frequency correction signal Fcorr, and the reference angular velocity ω0.

In this example, the frequency command value is calculated, by inputting the difference between the effective power command value Pref and the inverter power supply effective power output Pout of the inverter power supply 10 into the transfer function that simulates the oscillation equation of the synchronous generator of 1/(Ms+d). In the example in FIG. 8, for stabilization, a correction term Kp_VSG is provided in parallel. However, for simplification, the correction term Kp_VSG may not be provided.

FIG. 9 is an explanatory diagram of an example of a transfer function for calculating the d-axis voltage command value Vdref in the second embodiment.

In more detail, the d-axis voltage command value Vdref is calculated according to the transfer function illustrated in FIG. 9, on the basis of the reactive power command value Qref, the inverter power supply reactive power output Qout, the voltage command value Vset, and the inverter power supply d-axis output voltage Vsd.

According to the present second embodiment, unlike the first embodiment, when the voltage, frequency, or the like fluctuates in the external system PW after the system interconnection, the frequency of the inverter power supply 10 changes with the characteristic of simulating the characteristics of the synchronous machine that is a rotary-type generator.

As a result, according to the present second embodiment, similar to the first embodiment, of the voltages at both ends of the circuit breaker 11, the differences between the voltage amplitudes, voltage frequencies, and voltage phases at both ends of the circuit breaker 11 are all equal to or less than a threshold. Hence, until the three-phase alternating current power from the external system PW and the three-phase alternating current power output from the inverter power supply 10 are in a synchronized state, the circuit breaker 11 will not be turned ON by the automatic injector 38.

Furthermore, according to the present second embodiment, even if the system conditions are such that the inverter power supply similar to the inverter power supply 10 of the present specification occupies most of the proportion of the power supplies, the system operator can apply the system stabilization control and frequency control subject to the same characteristics as those of the control of the existing synchronous machine power supply.

### Third Embodiment

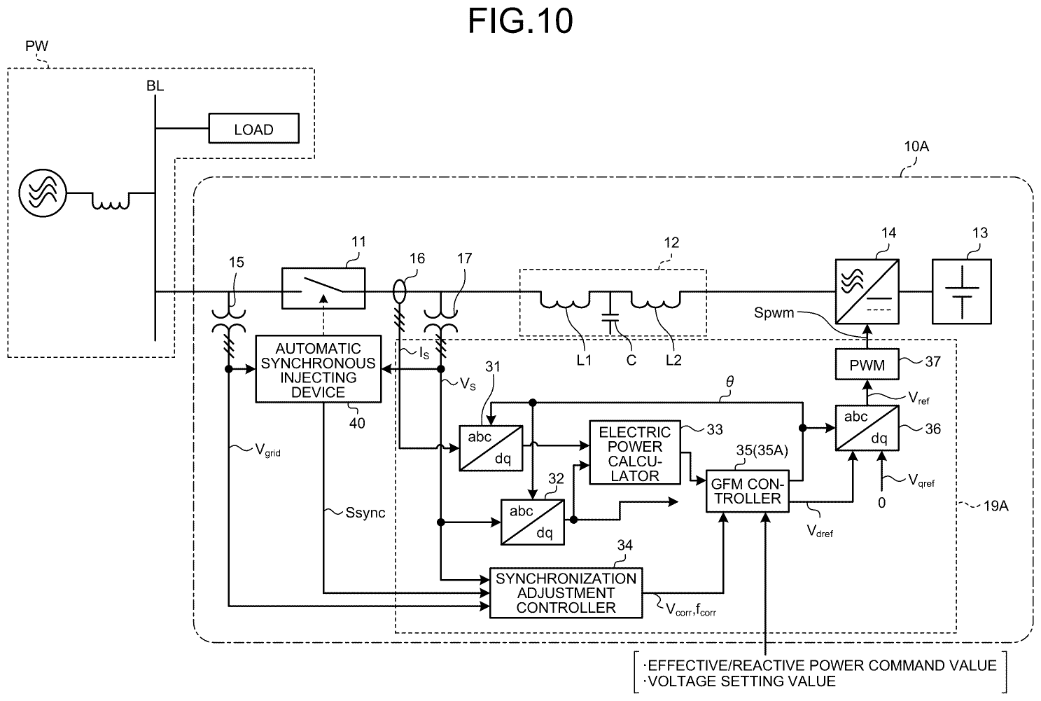

FIG. 10 is a schematic configuration block diagram of an electric power supply system of a third embodiment.

In FIG. 10, the same reference numerals denote the same portions as those in the first embodiment in FIG. 2.

As illustrated in FIG. 10, the present third embodiment is different from the first embodiment in that the frequency adjustment for the synchronization adjustment control is performed using an acceleration/deceleration signal Ssync generated by an automatic synchronous injecting device externally attached to the controller 19 of the controller 19.

In this example, the acceleration/deceleration signal is a signal to equalize the frequencies of the voltage corresponding to the first voltage detection signal Vgrid and the voltage corresponding to the second voltage detection signal Vs that are voltages at both ends of the circuit breaker 11. For example, the acceleration/deceleration signal is configured as a pulse signal.

As illustrated in FIG. 10, a controller 19A of the inverter power supply 10A in the third embodiment includes the first coordinate system conversion unit 31 that performs abc-dq conversion on the first electric current detection signal Is on the basis of the phase θ, and outputs the converted first electric current detection signal Is; the second coordinate system conversion unit 32 that converts the voltage detection signal Vs from the abc coordinate system to the dq coordinate system (abc-dq conversion) on the basis of the phase θ, and outputs the converted voltage detection signal Vs; the electric power calculator 33 that calculates electric power on the basis of the voltage detection signal Vs on which the abc-dq conversion is performed and the electric current detection signal on which the abc-dq conversion is performed; the synchronization adjustment controller 34 that calculates and outputs the voltage correction signal Vcorr and the frequency correction signal Fcorr, on the basis of the first voltage detection signal Vgrid output by the first voltage sensor 15 and the second voltage detection signal Vs output by the second voltage sensor 17; the GFM controller 35 that calculates the phase θ of the output voltage and the d-axis voltage command value Vdref of the output voltage, by performing droop-based GFM control on the basis of the value of the electric power calculated by the electric power calculator 33 and the value of the voltage detection signal Vs on which the abc-dq conversion is performed; the third coordinate system conversion unit 36 that converts the d-axis voltage command value Vdref and the q-axis voltage command value Vqref from the dq coordinate system to the abc coordinate system (dq-abc conversion) on the basis of the phase θ, and outputs the converted d-axis voltage command value Vdref and q-axis voltage command value Vqref as the reference voltage signals Vref; and the PWM controller 37 that generates the PWM control signal Spwm on the basis of the reference voltage signals Vref, and that performs PWM control on the converter circuit 14 configured as an inverter circuit.

Furthermore, the inverter power supply 10A of the third embodiment includes an automatic synchronous injecting device 40 that injects the circuit breaker 11, by determining that the synchronization conditions are met, when each difference between the amplitudes, frequencies, and phases of both voltages is equal to or less than a threshold, on the basis of the first voltage detection signal Vgrid and the second voltage detection signal Vs.

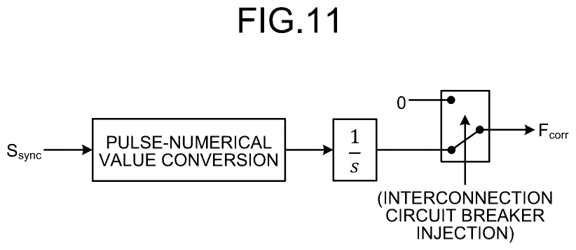

FIG. 11 is an explanatory diagram of an example of a transfer function for calculating the frequency correction signal Fcorr in the third embodiment.

In more detail, the synchronization adjustment controller 34 calculates the frequency correction signal Fcorr according to the transfer function illustrated in FIG. 11 including a process of converting pulses into numerical values and an integration process, on the basis of the acceleration/deceleration signal Ssync, and outputs the calculated frequency correction signal Fcorr to the GFM controller 35.

Then, the GFM controller 35 performs GFM control on the basis of the input frequency correction signal Fcorr, calculates the phase θ of the output voltage, and outputs the phase θ to the first coordinate system conversion unit 31, the second coordinate system conversion unit 32, and the third coordinate system conversion unit 36.

In this case also, when the circuit breaker 11 is injected, frequency correction signal Fcorr=0 holds.

As a result, by using the acceleration/deceleration signal Ssync that can be output from the external automatic synchronous injecting device for the synchronous adjustment control, it is possible to configure the device with a simple mechanism using a synchronous injecting device.

As described above, according to the present third embodiment, similar to the first embodiment, in a state where the inverter power supply is performing GFM control for building up the voltage while changing the frequency of the output voltage according to the output electric power of the inverter power supply, the circuit breaker 11 is injected when the synchronization conditions are met, that is, of the voltages at both ends of the circuit breaker 11, when the differences between the voltage amplitudes, voltage frequencies, and voltage phases at both ends of the circuit breaker 11 are all equal to or less than a threshold. Consequently, there is no need to switch the control of the inverter power supply to the system interconnection control to follow the voltage and frequency of the external system PW, after the circuit breaker 11 is injected.

Moreover, the inverter power supply can be operated continuously and stably, even if the frequency or voltage of the external system fluctuates after the system interconnection.

Furthermore, it is possible to stably activate the inverter power supply without depending on the status (the short-circuit capacity and the size of inertia) of the system to be interconnected.

In the above description, the external automatic synchronous injecting device 40 is used. However, by allowing the automatic injector 38 in the first embodiment and second embodiment to have the same function as that of the automatic synchronous injecting device 40, it is possible to allow the synchronization adjustment controller 34 in the first embodiment and second embodiment to calculate the frequency correction signal Fcorr according to the transfer function illustrated in FIG. 11 including the process of converting pulses into numerical values and the integration process, on the basis of the acceleration/deceleration signal Ssync, and output the calculated frequency correction signal Fcorr to the GFM controller 35.

Consequently, in the first embodiment and second embodiment also, it is possible to match the frequencies of the output voltage of the inverter power supply 10 with the voltage (system voltage) of the external system.

The controller of the electric power conversion device in the present embodiment has a hardware configuration using a normal computer.

A computer program to be executed by the controller of the electric power conversion device in the present embodiment is provided by being recorded in a computer readable recording medium such as a USB memory, a semiconductor memory device like a Solid State Drive (SSD), and a Digital Versatile Disk (DVD) in an installable or executable file format.

Moreover, the computer program to be executed by the controller of the electric power conversion device in the present embodiment may be stored on a computer connected to a network such as the Internet, and may be provided by being downloaded via the network. Furthermore, the computer program to be executed by the controller of the electric power conversion device in the present embodiment or the EMS may be provided or distributed via a network such as the Internet.

Still furthermore, the computer program of the controller of the electric power conversion device in the present embodiment or the EMS may be provided by being incorporated in the ROM or the like in advance.

While some embodiments of the present invention have been described, these embodiments are merely examples, and are not intended to limit the scope of the invention. These novel embodiments can be implemented in various other forms, and various omissions, replacements, and changes can be made without departing from the gist of the invention. These embodiments and their modifications are included in the scope and gist of the invention, and are also included in the invention described in the claims and the equivalent scope thereof.

1. An electric power conversion device comprising: a converter circuit that converts direct current power to alternating current power;
a circuit breaker one end of which is connectable to an external system and another end of which is connected to the converter circuit via a filter circuit; and
an injector that, before injecting the circuit breaker during activation, sets the converter circuit to an operating state, determines whether a voltage at the one end and a voltage at the other end meet a synchronization condition, and injects the circuit breaker when the synchronization condition is met.

2. The electric power conversion device according to claim 1, wherein the converter circuit is subjected to voltage-controlled converter control, and
droop control is used as the voltage-controlled converter control.

3. The electric power conversion device according to claim 1, wherein the conversion circuit is subject to voltage-controlled converter control, and
VSG control is used as the voltage-controlled converter control.

4. The electric power conversion device according to claim 1, wherein an acceleration/deceleration signal output by the injector is used for controlling a frequency of an output voltage of the converter circuit via the filter circuit and a frequency of a voltage of the external system to match with each other.

5. A control method for an electric power conversion device that includes a converter circuit for converting direct current power to alternating current power, and a circuit breaker one end of which is connectable to an external system and another end of which is connected to the converter circuit via a filter circuit, the method comprising:
setting the converter circuit to an operating state before injecting the circuit breaker during activation;
detecting a voltage at the one end and a voltage at the other end;
determining whether the voltage at the one end and the voltage at the other end meet a synchronization condition; and
injecting the circuit breaker when the synchronization condition is met in the determining.

6. The control method for the electric power conversion device according to claim 5, wherein the determining includes determining that the synchronization condition is met, when each of differences between amplitudes, frequencies, and phases of the voltage at the one end and the voltage at the other end is equal to or less than a threshold.
